(19) United States
(12) Patent Application Publication
(10) Pub. No.: US 2002/0129259 A1
(43) Pub. Date: Sep. 12, 2002

(54) System and method for accessing peripheral devices

(76) Inventor: Scott Johnson Chatterton, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/799,827

(22) Filed: Mar. 6, 2001

(51) Int. Cl. H04L 9/00

(52) U.S. Cl. 713/185

(57) ABSTRACT

The present disclosure relates to a system and method for accessing a peripheral device. The method comprises the step of storing user information in a portable computing device, and transmitting the user information from the portable computing device to the peripheral device such that the peripheral device receives the user information and confirms the authorization of the user to use the peripheral device.

### FIELD OF THE INVENTION

The present disclosure relates to a system and method for accessing peripheral devices. More particularly, the disclosure relates to a system and method for automatically accessing a peripheral device with a portable computing device.

### BACKGROUND OF THE INVENTION

In multiple-user environments such as offices, entry of an authorization code and/or a billing code is often required before a user can access and use peripheral devices such as photocopiers, facsimile machines, scanners, and digital senders. Normally, the code or codes are entered into a numeric keypad that is attached to the peripheral device or integrated therewith. Typically, the authorization code comprises a personal code assigned to the user that identifies the user to the peripheral device and the billing code comprises a code that identifies the project or matter to which any costs associated to the device operation will be billed. By requiring entry of such codes, only authorized users are able to use the device and use costs can be allocated to the correct projects or matters. In some situations, additional codes must be entered where particular functionality is desired. For instance, an additional code may be required where the user wishes to send a facsimile to a long distance recipient.

Although users could carry a list of the necessary codes on their person at all times to ensure that they will have the codes at the ready when they wish to use a peripheral device, users instead typically rely on memorization alone. Unfortunately, in that the codes are numeric and typically non-intuitive, it can be difficult for the user to remember all the codes he or she will need to operate the peripheral devices. This is particularly true in the case of billing codes where the user works on numerous projects or matters. Accordingly, if the user forgets a code, he or she may need to interrupt use of the peripheral device, locate the code, and again attempt to access and use the peripheral device. Even where the user does remember all necessary codes, he or she still must go through the process of manually entering all of the characters of the codes into the keypad. Entry of the codes can be cumbersome, particularly where the user accesses and uses the peripherals on many separate occasions each day.

From the above, it can be appreciated that it would be desirable to have a system and method with which a user can automatically communicate his or her authorization to use a peripheral device without the need to manually enter one or more codes.

### SUMMARY OF THE INVENTION

The present disclosure relates to a system and method for accessing a peripheral device. The method comprises the step of storing user information in a portable computing device, and transmitting the user information from the portable computing device to the peripheral device such that the peripheral device receives the user information and confirms the authorization of the user to use the peripheral device.

In one embodiment, the system comprises means for storing user information in a portable computing device, means for transmitting the user information from the portable computing device, means for receiving the user information at the peripheral device, and means for confirming the authorization of the user to use the peripheral device. In another embodiment, the system comprises logic configured to store user information in a portable computing device, logic configured to transmit the user information from the portable computing device, logic configured to receive the user information at the peripheral device, and logic configured to confirm the authorization of the user to use the peripheral device.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view that illustrates an example environment for the system and method of the present invention.

FIG. 2 is a schematic view that illustrates an example architecture of a computing device shown in FIG. 1.

FIG. 3 is a flow diagram that illustrates the operation of a peripheral access module shown in FIG. 2.

FIG. 4 is a schematic view that illustrates an example architecture of a portable computing device shown in FIG. 1.

FIG. 5 is a flow diagram that illustrates the operation of a peripheral access module shown in FIG. 4.

FIG. 6 is a schematic view that illustrates an example architecture of a peripheral device shown in FIG. 1.

FIG. 7 is a flow diagram that illustrates the operation of a peripheral access module shown in FIG. 6.

FIG. 8 is a flow diagram that describes a method for using a portable device to access a peripheral device with the system of FIG. 1.

### DETAILED DESCRIPTION

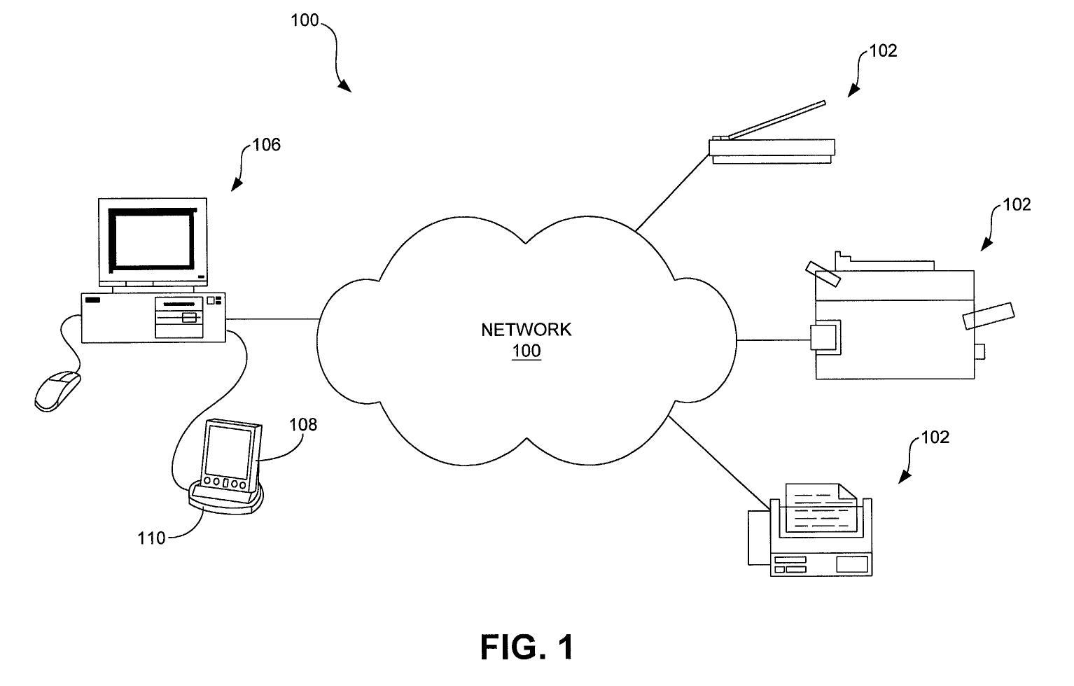

Referring now in more detail to the drawings, in which like numerals indicate corresponding parts throughout the several views, FIG. 1 illustrates an example environment 100 for the present invention. The system 100 can comprise a plurality of peripheral devices 102 that, by way of example, are connected to a network 104 such as an office network. As indicated in FIG. 1, the peripheral devices 102 can take different forms. By way of example, a given peripheral device 102 can comprise a photocopier, facsimile machine, scanner, digital sender, or a combination thereof. Also shown connected to the network 104 is a computing device 106 that, as indicated in FIG. 1, can comprise a desktop computer. Electrically connected to the computing device 106 is a portable computing device 108. By way of example, the portable computing device 108 comprises a personal digital assistant (PDA), however it will be understood that the portable computing device can comprise substantially any portable device capable of storing information and communicating it to a peripheral device, including a mobile telephone. Normally, electrical connection between the computing device 106 and the portable computing device 108 is provided by an interface device 110 such as a PDA cradle that is adapted to receive and electrically connect to the portable computing device.

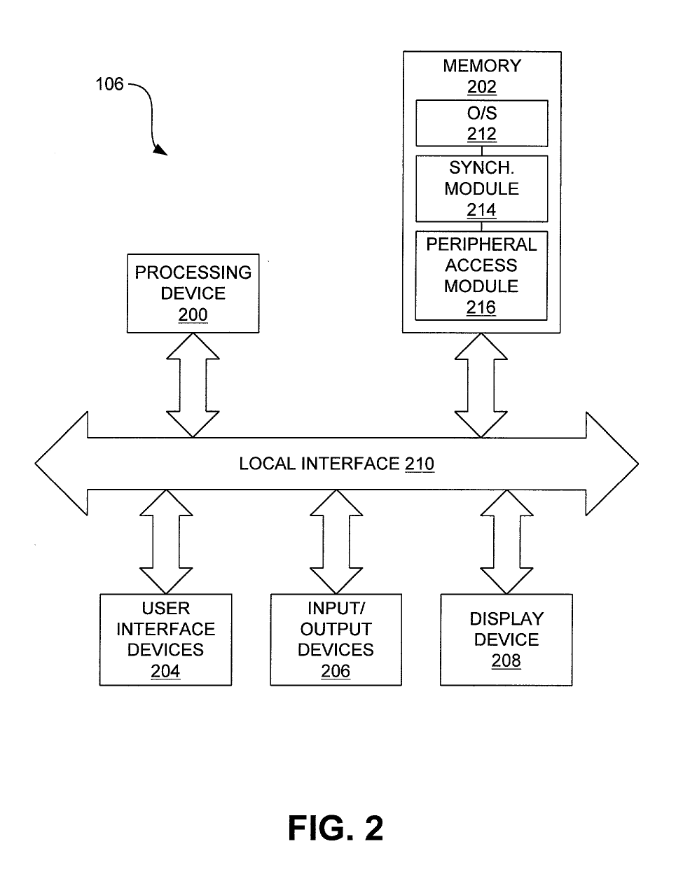

FIG. 2 is a schematic view illustrating an example architecture for the computing device 106 shown in FIG. 1. As indicated in FIG. 2, the computing device 106 comprises processing device 200, memory 202, user interface devices 204, input/output devices 206, a display device 208, and a local interface 210 to which each of the other components electrically connects. The processing device 200 is adapted to execute commands stored in memory 202 and typically comprises one or more central processing units (CPUs). The user interface devices 204 comprise user interface tools with which the user can communicate commands to the computing device 106, for example, a keyboard and mouse. The input/output devices 206 comprise the various interface elements through which data can be transmitted from and received by the computing device 106. By way of example, the devices 206 can include a modem or other communications device as well as the hardware with which electrical connections can be made with the computing device 106. As indicated in FIG. 1, the display device 208 can comprise a monitor or other display screen with which information can be visually communicated to the user.

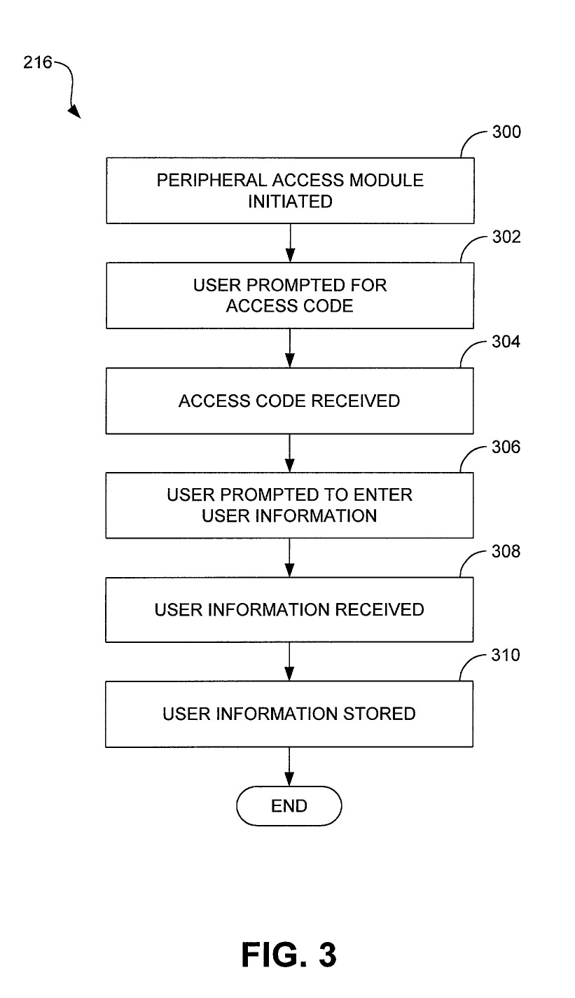

As identified in FIG. 2, memory 202 comprises an operating system 212, a synchronization module 214, and a peripheral access module 216. The operating system 212 contains the various commands used to control general operation of the computing device 106. The synchronization module 214 comprises software and/or firmware that is adapted to facilitate synchronization of the portable computing device 108 with the computing device 106. Finally, the peripheral access module 216 comprises software and/or firmware that is adapted to facilitate the download of user information to the portable computing device 108. FIG. 3 is a flow diagram that illustrates the functionality of the peripheral access module 216. As indicated in block 300, the module is first initiated within the computing device 106. This initiation typically occurs in response to user activation of the module 216 by, for example, the user selecting an icon presented to the user via the display device 208. Once initiated, the module 216 prompts the user for one or more access codes, as indicated in block 302. By way of example, the user can be prompted to enter a username and password that has been selected by or assigned to the user.

Once these access codes have been entered, they are received by the module 216, as indicated in block 304, and the user is prompted to enter user information, as indicated in block 306. This information typically comprises the information that is required of the user to access one or more peripheral devices. Accordingly, this information may comprise a user access code, one or more applicable billing codes, and any other codes relevant to accessing any desired peripheral device functionality for which the user is authorized. In addition, the user information can comprise user settings that explicitly identify who the user is. For instance, where the user wishes to access a facsimile machine, the information can include the user's name and personal telephone number, so that both or either can be communicated to the facsimile recipient. In another example, where the user wishes to access a digital sending device or multiple-function peripheral device capable of sending data via email, the information can include the user's name and/or the user's email address. Furthermore, the user information can include the user's default preferences for using the peripheral devices. Such preferences can comprise formatting preferences settings such as preferred paper type, preferred method of transmission, default billing code preferences, etc. Once the user information has been entered, it is received by the module 216, as indicated in block 308, and is stored, as indicated in block 310.

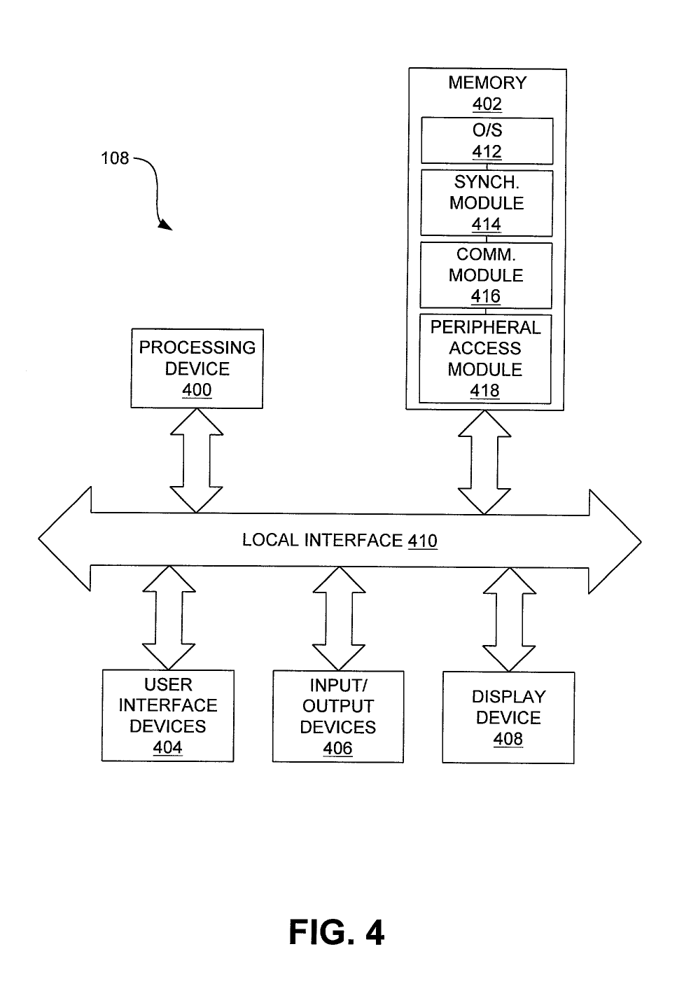

FIG. 4 is a schematic view illustrating an example architecture for the portable computing device 108 shown in FIG. 1. As with the computing device 106, the portable computing device 108 comprises a processing device 400, memory 402, user interface devices 404, input/output devices 406, a display device 408, and a local interface 410 to which each of the other components electrically connects. The processing device 400 is adapted to execute commands stored in memory 402 and typically comprises one or more central processing units (CPUs). The user interface devices 404 typically comprise user interface tools such as a key pad and touch-sensitive screen with which the user can communicate commands to the portable computing device 108. The input/output devices 406 typically comprise interface elements through which data can be transmitted from and received by the portable computing device 108. By way of example, these devices 406 can include the hardware with which data is downloaded to the device 108 and transmitted from the device (e.g., via connection to interface device 110) and a wireless transmitter with which data can be wirelessly transmitted from the portable computing device. By way of example, the wireless transmitter can comprise an infrared (IR) or a short range radio frequency (RF) transmitter. An example radio frequency communication protocol is Bluetooth™ protocol from Bluetooth SIG™. The display device 408 can comprise a display screen such as a liquid crystal display (LCD). Where the user interface devices 404 include a touch-sensitive screen, the display screen can comprise a touch-sensitive LCD.

As identified in FIG. 4, memory 402 comprises an operating system 412, a synchronization module 414, a communications module 416, and a peripheral access module 418. The operating system 412 contains the various commands that control general operation of the portable computing device 108, the synchronization module 414 is adapted to facilitate synchronization with the computing device 106, and the communications module 416 is adapted to initiate and participate in communications with other devices such as one or more peripheral devices. In a preferred arrangement, the communications module 416 comprises software and/or firmware that is adapted to wirelessly communicate with the peripheral devices through either IR or short range RF communications. The peripheral access module 418 comprises software and/or firmware that is adapted to facilitate the authorization of a user to access and use the one or more peripheral devices. In particular, this module 418 stores the user information to be communicated to the peripheral devices. Although a downloading process has been described above, it is to be understood that this information could, alternatively, be entered by the user directly into the portable computing device 108, if desired. Normally, however, the information is downloaded from a separate computing device to simplify the data entry process.

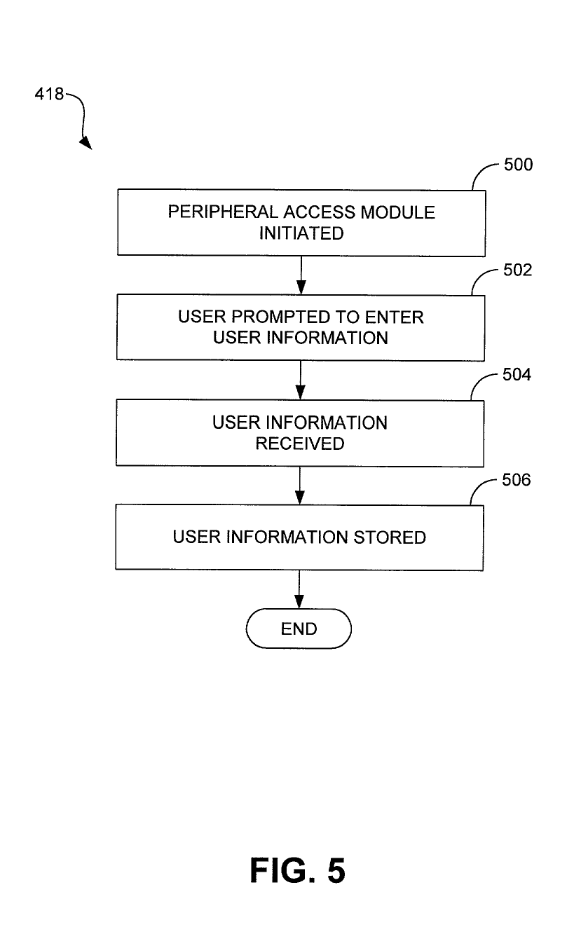

FIG. 5 is a flow diagram that illustrates the functionality of the peripheral access module 418. Where user information is not downloaded to the portable computing device 108 from another device, the module 418 is first initiated, as indicated in block 500. As with the computing device 106, this initiation typically occurs in response to user activation of the module 418 by, for example, selection of an icon presented to the user via the display device 408. Once initiated, the module 418 prompts the user to enter the user information described above, as indicated in block 502. Notably, entry of a user access code may not be necessary where the entry of such a code is required for access of the portable computing device 108 generally. However, it will be understood that the module 418 can, optionally, be configured to first require such an access code from the user. Once the user information has been entered, it is received by the module 418, as indicated in block 504, and is stored, as indicated in block 506.

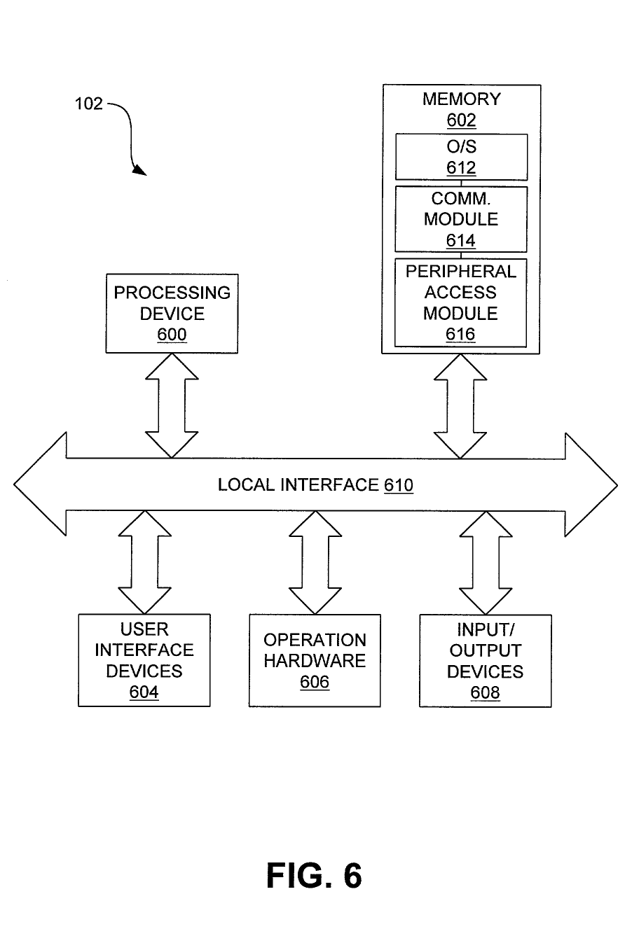

FIG. 6 is a schematic view illustrating an example architecture for a peripheral device 102 that the user wishes to access via the system and method of the present invention. The peripheral device 102 typically comprises a processing device 600, memory 602, user interface devices 604, operation hardware 606, input devices 608, and a local interface 610 (e.g., one or more internal buses) to which each of the other identified components electrically connects. The processing device 600 is adapted to execute commands stored in memory 602. The processing device 600 can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the peripheral device 102.

The user interface devices 604 typically comprise user interface tools such as various function keys that are used to operate the peripheral device 102 and a display screen in which the status of the device can be communicated to the user. The operation hardware 606 comprises the various mechanisms used to perform the functionalities for which the peripheral device 102 is adapted (e.g., photocopying, faxing, scanning, digital sending). The input/output devices 608 typically comprise interface elements through which data can be transmitted from and received by the peripheral device 102. By way of example, the devices 608 can include a wireless receiver through which data can be wirelessly received by the peripheral device 102 (e.g., IR or RF communications).

As identified in FIG. 6, memory 602 comprises an operating system 612, a communications module 614, and a peripheral access module 616. The operating system 612 contains the various commands used to control general operation of the peripheral device 102. The communications module 414 comprises software and/or firmware that is adapted to facilitate communications with the portable computing device 108. In a preferred arrangement, the communications module 614 is adapted to wirelessly communicate through either IR or short range RF communications. The peripheral access module 616 comprises software and/or firmware that is adapted to facilitate the authorization of a user to access and use the peripheral device 102. In particular, the peripheral access module 616 is adapted to confirm authorization of the user based on the user information that is transmitted to the peripheral device 102 from the portable computing device 108.

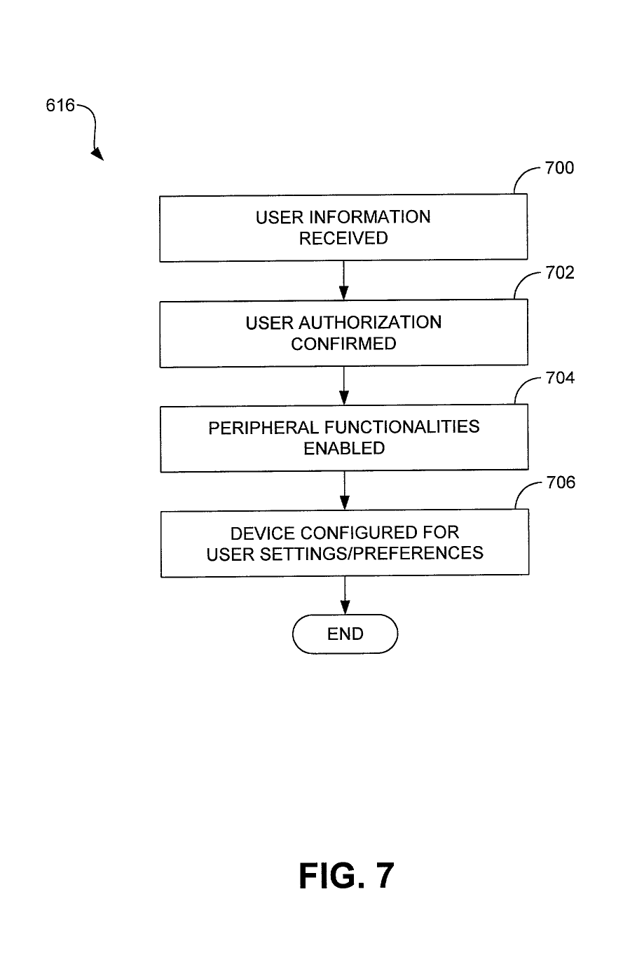

FIG. 7 is a flow diagram that illustrates the functionality of the peripheral access module 616. As indicated in this figure, the peripheral access module 616 first receives user information from the portable computing device 108, as indicated in block 700. Once the information is received, the module 616 confirms the user's authorization to access and use the peripheral device 102, as indicated in block 702. More specifically, the module 616 confirms that the user has authorization to use the peripheral device 102 and further determines the various device functionalities for which the user has authorization. Once this confirmation/determination has occurred, the various functionalities are enabled for the user, as indicated in block 704. In addition to enabling device functionalities, the module 616 can further configure relevant user settings and/or preferences transmitted from the portable computing device 108, as indicated in block 706. As noted above, the settings can comprise user identifiers as the user's name, user's phone number, user's email address, and the like, and the user preferences can comprise the user's default preferences such as formatting, default billing code, etc.

Various software and/or firmware modules have been described herein. It is to be understood that these modules can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

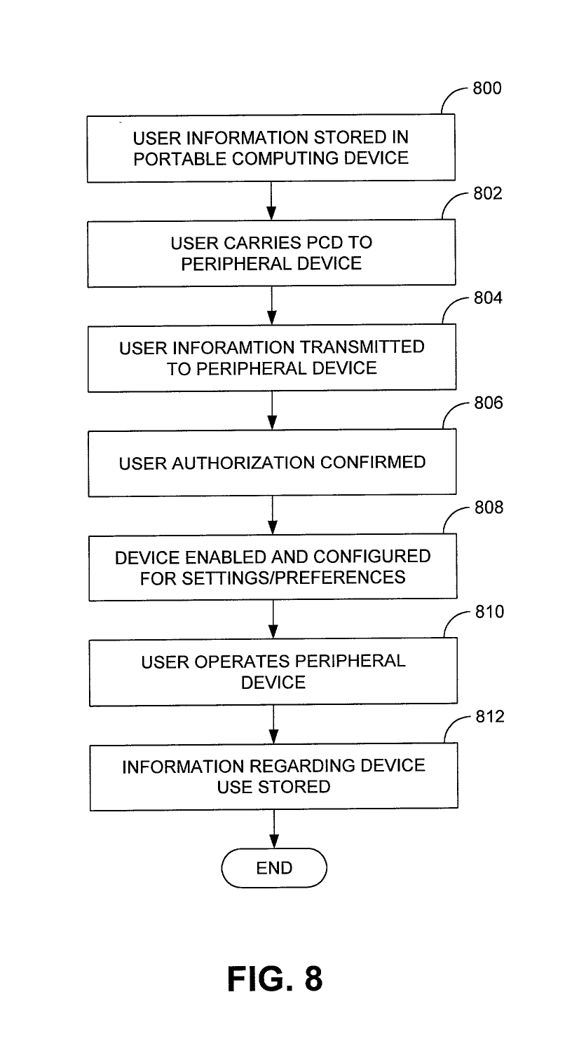

Operation of the inventive system and method will now be described with reference to FIG. 8. As shown in this figure, the user information is first stored in the portable computing device 108, as indicated in block 800. As discussed above, this information can be stored in the device 108 by directly entering the information into the device or can first be entered into the peripheral access module 216 of the computing device 106 and downloaded to the portable computing device 108. In either case, this information includes any user access codes, billing codes, user settings, user preferences, etc. that may be relevant to the user's operation of a peripheral device 102. Once this information is stored in the portable computing device 108, e.g., in the peripheral access module 418, the portable computing device can be used to automatically access one or more peripheral devices 102. To do so, the user carries the portable computing device 108 (PCP) with him or her to the peripheral device 102, as indicated in block 802. In that the portable computing device 108 is normally small and a device of the type that is often carried on one's person, normally no inconvenience is imposed upon the user.

The user can then transmit the user information to the peripheral device 102, as indicated in block 804. In particular, the user can direct the portable computing device 108 at the peripheral device 102 and activate the portable computing device to wirelessly transmit the user information. As noted above, this transmission of the user information is typically accomplished through IR or short range RF communications. Normally, this transmission is initiated by the user by manipulating the user interface devices 404. For instance, the portable computing device 108 can be configured so as to have a shortcut key that transmits the user information when pressed. Alternatively, the user can access the peripheral access module 418 via a touch-sensitive LCD of the device 108. Although wireless communication is preferred due to its convenience, it will be understood that alternative transmission methods could be used such as direct electrical connection between the portable computing device 108 and the peripheral device 102.

It is to be noted that, before transmitting the user information, the user can wish to make various selections with the portable computing device 108. By way of example, where the user is authorized to use more than one billing code, the user may wish (if not already designated as a default code) to first select the billing code to be used for a particular use before transmitting the user information to the peripheral device 102. Typically, such a selection can easily be made due to the provision of the display device 408 of the portable computing device 108. For example, the user can be presented with a list of projects or other matters and their associated billing numbers to simplify the billing code selection process. In addition to selections relative to the billing code, it will be appreciated that the user can make other selections prior to transmission, for instance selections as to the user's formatting preferences, if desired.

Once the user information is transmitted, the user's authorization to access the peripheral device 102 and the extent of this authorization is determined by the peripheral device, as indicated in block 806. At this point, the various functionalities for which the user is authorized (and has selected if applicable) are enabled and the peripheral device 102 is configured for any user settings and/or preferences that have been transmitted, as indicated in block 808. The user can then operate the peripheral device 102 as desired, as indicated in block 810. As is conventionally the case, the user can manually adjust the settings of the peripheral device 102 after accessing the device. Optionally, the peripheral access modules 418 and 616 of the portable computing device 108 and peripheral device 102, respectively, can be configured such that certain pieces of the user information cannot be changed. By way of example, the modules may be configured such that the user cannot change his or her user identifier (e.g., the user name, phone number, email address) to prevent the anonymous transmission of inappropriate materials. After the user has operated the peripheral device 102, the peripheral access module 616 of the device can store information regarding the use, as indicated in block 812. This information may include the identity of the user, duration of use, number of copies made, number of the phone numbers/email addresses transmitted to, and the like. By storing information in this manner, a detailed record of the peripheral device's use can be maintained and later checked, if desired. At this point, the user can access and operate another peripheral device 102 in similar manner, if desired.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for accessing a peripheral device, comprising the steps of:
storing user information in a portable computing device; and
transmitting the user information from the portable computing device to the peripheral device such that the peripheral device receives the user information and confirms the authorization of the user to use the peripheral device.

2. The method of claim 1, wherein the user information comprises a user access code and a billing code.

3. The method of claim 1, wherein the user information comprises the user's name.

4. The method of claim 1, wherein the user information comprises the user's phone number.

5. The method of claim 1, wherein the user information comprises the user's email address.

6. The method of claim 1, wherein the step of transmitting the user information comprises the step of wirelessly transmitting the user information from the portable computing device to the peripheral device.

7. The method of claim 1, wherein the portable computing device comprises a personal digital assistant (PDA).

8. The method of claim 1, wherein the portable computing device comprises a mobile telephone.

9. A system for accessing a peripheral device, comprising:
means for storing user information in a portable computing device;
means for transmitting the user information from the portable computing device;
means for receiving the user information at the peripheral device; and
means for confirming the authorization of the user to use the peripheral device.

10. The system of claim 9, wherein the means for storing user information comprises means for downloading the user information to the portable computing device from a separate computing device.

11. The system of claim 9, wherein the means for transmitting the user information comprises means for wirelessly transmitting the user information and wherein the means for receiving the user information comprises means for wirelessly receiving the user information.

12. The system of claim 9, further comprising means for confirming the identity of the user prior to transmission from the portable computing device.

13. The system of claim 12, wherein the means for confirming the identify of the user comprises means for receiving and confirming an access code of the user.

14. The system of claim 9, further comprising means for automatically populating data fields at the peripheral device with the user information.

15. The device of claim 9, further comprising means for automatically configuring the peripheral device as per user preferences contained in the user information.

16. A system for accessing a peripheral device, comprising:
logic configured to store user information in a portable computing device;
logic configured to transmit the user information from the portable computing device;
logic configured to receive the user information at the peripheral device; and
logic configured to confirm the authorization of the user to use the peripheral device.

17. The system of claim 16, wherein the logic configured to store user information comprises logic configured to download the user information to the portable computing device from a separate computing device.

18. The system of claim 16, wherein the logic configured to transmit the user information comprises logic configured to wirelessly transmit the user information and wherein the logic configured to receive the user information comprises logic configured to wirelessly receive the user information.

19. The system of claim 16, further comprising logic configured to confirm the identity of the user prior to transmission from the portable computing device.

20. The system of claim 19, wherein the logic configured to confirm the identify of the user comprises logic configured to receive and confirm an access code of the user.

21. The system of claim 16, further comprising logic configured to automatically populate data fields at the peripheral device with the user information.

22. The device of claim 16, further comprising logic configured to automatically configure the peripheral device as per user preferences contained in the user information.

23. A portable computing device, comprising:
logic configured to receive and store user information;
a wireless transmitter adapted to wirelessly transmit data to a peripheral device; and
logic configured to wirelessly transmit the user information to the peripheral device via the wireless transmitter.

24. The device of claim 23, further comprising logic configured to confirm the identity of the user prior to transmission of the user information.

25. The device of claim 24, wherein the logic configured to confirm the identify of the user comprises logic configured to receive and confirm an access code of the user.

26. The device of claim 23, wherein the portable computing device comprises a personal digital assistant (PDA).

27. The device of claim 23, wherein the portable computing device comprises a mobile telephone.

28. A peripheral device, comprising:
a wireless receiver adapted to wirelessly receive user information transmitted from a peripheral device;
logic configured to confirm the authorization of the user from the user information; and
logic configured to enable the peripheral device for use if authorization is confirmed.

29. The device of claim 28, further comprising logic configured to automatically populate data fields with the user information.

30. The device of claim 28, further comprising logic configured to automatically configure the peripheral device as per user preferences contained in the user information.
